(19) United States
(12) Patent Application Publication
(10) Pub. No.: US 2012/0063332 A1
(43) Pub. Date: Mar. 15, 2012

(54) SYSTEM AND METHOD FOR DETERMINING AND CONTROLLING LOOPBACK POINTS IN A NETWORK ENVIRONMENT

(75) Inventors: M. David Hanes, Lewisville, NC (US); James C. Frauenthal, Colts Neck, NJ (US); Michael P. O'Brien, Manasquan, NJ (US)

(73) Assignee: Cisco Technology, Inc.

(21) Appl. No.: 12/879,910

(22) Filed: Sep. 10, 2010

(51) Int. Cl. H04L 12/26

(52) U.S. Cl. 370/249

(57) ABSTRACT

A method is provided in one example and includes establishing a path for a media session between a first network element and a second network element. A third network element is detected along the path. A response is received from the third network element indicating that it is capable of performing a loopback activity that involves the first network element. A test packet is communicated from the first network element to the third network element in order to evaluate characteristics associated with the media session. In more specific implementations, the response includes an indication as to a proximity of the third network element in relation to the first network element. The first network element can receive additional responses from a plurality of network elements such that the first network element generates a list of available network elements for performing loopback activities.

### TECHNICAL FIELD

This disclosure relates in general to the field of communications and, more particularly, to determining and controlling loopback points in a network environment.

### BACKGROUND

Networking architectures have grown increasingly complex in communication environments. As these architectures have become more sophisticated, problems in determining the source of media stream impairments have arisen. Testing protocols (such as loopbacks) have become more prominent in certain networking architectures. The concept of a loopback was previously used in traditional telephony scenarios for troubleshooting digital circuits such as T1/E1 links. Suitable testing is typically conducted in order to identify the source of the network problem, where some remedial measure would subsequently occur. The ability to offer viable strategies and resolutions for problematic network issues, without sacrificing performance, presents a significant challenge to component manufacturers, network operators, and service providers alike.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for determining and controlling loopback points in a network environment in accordance with one embodiment of the present disclosure;

FIG. 2 is a simplified block diagram illustrating possible example details associated with the communication system;

FIG. 3 is a simplified flowchart illustrating one possible operation associated with the communication system;

FIG. 4 is a simplified block diagram illustrating one potential packet format associated with the present disclosure;

FIG. 5 is a simplified flowchart illustrating one possible operation associated with the communication system; and

FIG. 6 is a simplified block diagram illustrating another potential packet format associated with the communication system.

### DETAILED DESCRIPTION OF EXAMPLE EMBODIMENTS

### Overview

A method is provided in one example and includes establishing a path for a media session between a first network element and a second network element. A third network element is detected along the path. A response is received from the third network element indicating that it is capable of performing a loopback activity that involves the first network element. A test packet is communicated from the first network element to the third network element in order to evaluate characteristics associated with the media session. In more specific implementations, the response includes an indication as to a proximity of the third network element in relation to the first network element. The first network element can receive additional responses from a plurality of network elements such that the first network element generates a list of available network elements for performing loopback activities.

In more specific implementations, a probe packet is communicated to the third network element, where the probe packet determines a loopback functionality. A loopback request could enable the loopback itself to be initiated. The response can include a counter set to zero initially, and incremented by one by the third network element. The characteristics associated with the media session being evaluated can include jitter, packet loss, and delay associated with the media session. The media session can include video data, audio data, voice data, etc.

### EXAMPLE EMBODIMENTS

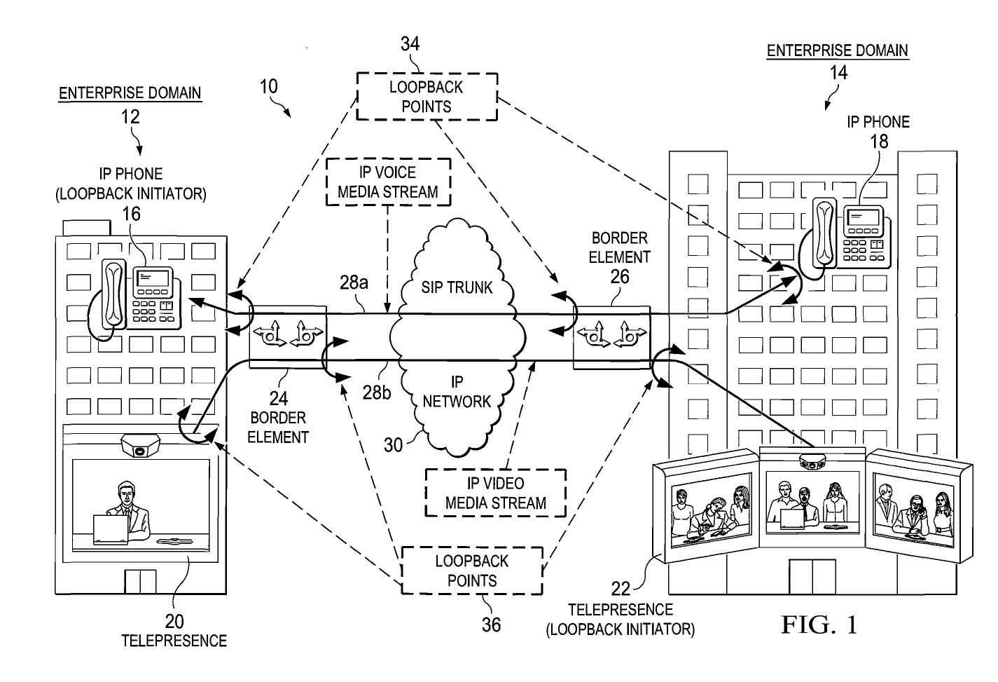

Turning to FIG. 1, FIG. 1 is a simplified block diagram of a communication system 10 for determining and controlling loopback points in a network environment. In this particular example, FIG. 1 may include an enterprise domain 12 and an enterprise domain 14. This particular example also includes a set of Internet protocol (IP) phones 16, 18, along with a set of endpoints for videoconferencing activities (i.e., a Telepresence endpoint 20, and a three-panel Telepresence endpoint 22). Each enterprise domain 12, 14 also includes a respective border element 24, 26, which can be provisioned at the edge of their respective domains. An IP network 30 can be provisioned between enterprise domain 12 and enterprise domain 14 for conducting any type of communications. In this particular example, an IP voice media stream 28a and an IP video media stream 28b are illustrated for purposes of discussion. Additionally, a set of loopback points 34 and 36 are also depicted, where these loopback points can involve any type of network element.

In one particular instance, communication system 10 can be associated with a Unified Communications (UC) deployment in which particular types of streams are flowing between enterprise domain 12 and enterprise domain 14. In other examples, communication system 10 would be equally applicable to other loopback environments. Communication system 10 may include a configuration capable of transmission control protocol/internet protocol (TCP/IP) communications for the transmission and/or reception of packets in a network. Communication system 10 may also operate in conjunction with a user datagram protocol/IP (UDP/IP) or any other suitable protocol, where appropriate and based on particular needs.

Operationally, session initiation protocol (SIP) trunks can connect enterprise domains 12 and 14. In this particular example of FIG. 1, border elements 24 and 26 are provisioned at ends of the SIP trunk, but any device with a border functionality could alternatively be used. Within each enterprise domain 12 and 14, there are numerous media streaming devices (e.g., Telepresence video conferencing systems, IP telephone communications, etc.). In accordance with certain teachings of the present disclosure, communication system 10 can identify a loopback for an individual IP media stream and, further, signal this identification to any device in the media stream path. This includes signaling this loopback condition to the remote endpoint. Such operations could provide enhanced troubleshooting of real-time media, as detailed below.

For purposes of illustrating certain example techniques of communication system 10, it is important to understand the communications that may be traversing the network. The following foundational information may be viewed as a basis from which the present disclosure may be properly explained. Testing strategies typically include some component of loopback identification. Loopback activities have been successfully conducted in traditional telephony environments (e.g., troubleshooting digital circuits such as T1/E1 links). Typically, service providers could remotely initiate loopbacks at a customer premises device. Once the targeted device was looped back, the service provider could perform bit error rate testing (BERT) to that loopback point in an effort to identify errors in the corresponding path. Such testing could determine the need for additional testing and, further, identify more loopbacks at other places in the path for purposes of narrowing down the source of the underlying problem (e.g., a device malfunction, a software issue, a link failure, a network outage, etc.). In certain use case scenarios, such testing would simply show that the connection was clean and, further, the problem resided in another portion of the path.

For IP media streams, the concept of loopback testing has been applied with dubious success. Certain call control protocols have been developed to remotely loopback media stream endpoints. Similarly, many voice gateways have the ability for a user to manually initiate a loopback on a particular voice over IP (VoIP) device, which may be tied to an individual media stream using a command line interface (CLI). However, such media stream loopback testing methodologies fail to offer comprehensive loopback testing, where loopbacks could be initiated remotely: without the need for a manual enablement of a loopback on a particular device. Moreover, no such protocol exists for evaluating loopbacks along the entire media stream path (i.e., not just the endpoints).

Communication system 10 can address these issues, and others, in offering a configuration for determining and for remotely controlling multiple loop back points in an IP media stream. This includes a mechanism to enable and to detect loopback support on an IP device. Additionally, communication system 10 can outline protocols for starting and stopping the loopback activities in the media stream and, further, coordinate the media stream in the opposite direction of the loopback. In general terms, communication system 10 supports real-time loopback troubleshooting for any type of media stream. These implementations can be critical to properly facilitate mid-call loopback troubleshooting.

Additionally, certain embodiments may offer an auto-discovery methodology, which determines loopback points along a dynamic media stream path. This provides a viable listing of loopback points, which may be ordered by proximity. From a troubleshooting perspective, this ordered listing (of loopback points) offers a holistic view of the media stream path, where the loopback points effectively divide the current media stream into network segments. Leveraging these loopback points, it is possible to quickly isolate and section (in real-time) the network segment where media stream degradation is occurring.

Moreover, embodiments presented herein can offer a mechanism for remotely enabling and disabling the specific loopback points, which have been identified (e.g., auto-discovered) in a media stream path. For example, end users on an IP phone can initiate loopback tests, while this same capability is available to network administrators. Such an approach would eliminate the need for manually determining (and then properly configuring) a loopback on devices on which there could be hundreds of ‘dial peers’ present. Note that the term ‘dial peer’ is simply referring to a routing attribute and an association mechanism for correlating media streams to phone numbers, routing of the stream, and defining a number of call attributes. These attributes can include codec, silence suppression, quality of service (QoS), call control protocol, etc.

In operational terms, any device in a network that initiates a loopback (e.g., for effectively troubleshooting) can be configured to perform the loopback capabilities outlined herein. For example, from the perspective of a service provider, devices on the edge of their networks could include such a capability for effectively addressing problem areas in their networks. When more devices in the network have this loopback initiating capability, then problematic network areas can be more specifically targeted. Any device with a layer 3 (L3) capability could be provisioned with the loopback initiator functionality. In one particular example, places of high traffic could be provided with the loopback initiator capability.

Note that the elements in the network (e.g., the router, IP phones, etc.) can have two mechanisms for performing the loopback activities discussed herein. For example, each of the endpoints can include a loopback initiator module, along with a response mechanism to interact with other devices in the network (e.g., a peer endpoint at the far end of the network). Similarly, devices in the media stream path can be configured to understand these loopback protocols. In one particular example, the devices in the path would first acknowledge that they have the loopback capability and, subsequently, move into a loopback mode based on instructions that they receive.

In terms of advantages, communication system 10 can offer an effective loopback for all configured devices in the IP media stream path. In contrast, current loopback implementations use the call control protocol: allowing them to only utilize terminating endpoints in their loopback scenarios. If there is a problem with an IP media stream (as it traverses an IP network), looping back the remote endpoint is of little value. For example, a network administrator already knows that the problem resides between point A and point B and, therefore, looping back media between these endpoints continues to exhibit the problem, but it fails to narrow down the problem source. By performing loopback testing to various devices in the media stream path (other than the endpoints), a network operator can isolate the particular network segment that is causing media stream degradation.

Additionally, communication system 10 (in certain embodiments) can offer a remote loopback initiation. It is currently possible to manually enable media stream loopbacks on media stream transit devices (e.g., such as certain border elements), but this requires a manual intervention by the user. Where multiple border elements exist in a media stream path, isolating a single media stream (out of the possible hundreds of media streams being handled by the border element) and, further, determining which peer needs to be configured for a loopback could present a challenge. It should also be noted that each media stream on a given border element has two call legs, where a network administrator should enable the loopback on the correct peer (or else the wrong media stream is looped or the correct media stream is looped but in the wrong direction). In contrast to these flawed operations, communication system 10 allows for the remote initiation of a loopback on a border element (or on any other L3 transit device), where it can ensure that the appropriate media stream is looped back in the appropriate direction.

In certain embodiments, communication system 10 can also offer a loopback discovery probe. This offers the ability to automatically discover loopback points in a media stream path. In turn, this can provide the endpoint with a listing (i.e., an effective mapping) of loopback nodes in the path (representing loopback test points). Additionally, these loopback nodes can be intelligently ordered in the media path by their proximity to the originating endpoint.

It should also be noted that communication system 10 can allow customers to troubleshoot large complex private networks non-intrusively. This is because the loopback occurs on the single media session and not at the interface level. It is critical for technical assistance centers to be able to troubleshoot these types of network issues without causing down time to the customer, or incurring wait times for a maintenance window. Also worthy of noting is that, with new features being developed in unified communications and computing (e.g., such as Inter-Company Media Engine (IME) that involves the creation of dynamic SIP trunks to many different customer networks), the teachings of communication system 10 can enable a technical assistance center (TAC) to have the necessary troubleshooting tools to effectively locate problems through customer networks, firewalls, etc.

From a more practical standpoint, as more and more service providers continue to migrate away from the role of a traditional public switched telephone network (PSTN) carrier (i.e., to IP carriers deploying SIP trunks and other IP connections to customers), the loopback activities outlined herein provide these entities with a familiar troubleshooting tool. This tool allows them to quickly hone in on customer issues that occur within their infrastructure. Additionally, being able to perform IP loopbacks to customer premise equipment (e.g., border elements) allows service providers to prove to their customers that they are not causing media degradation problems. From this point, the service provider can then help their customers isolate where the issue is occurring. In different environments that involve the enterprise and commercial arenas, network administrators are consistently seeking tools that allow them to quickly and to efficiently resolve media stream problems for their users. Additionally, the loopback capabilities defined herein can allow these entities to determine if their IP carrier is degrading their media, or if the problem is occurring on their own network. Before discussing potential flows associated with the architecture of FIG. 1, a brief discussion is provided about some of the possible infrastructure that may be included in communication system 10.

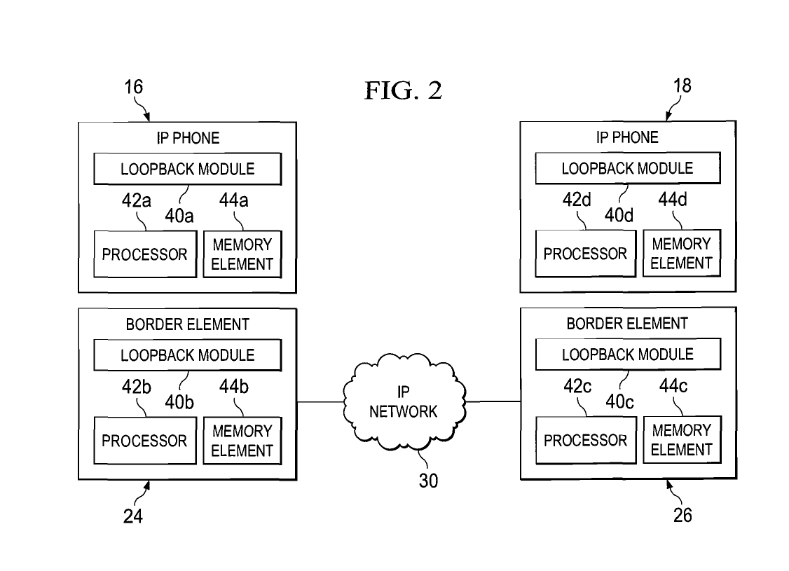

Turning now to FIG. 2, FIG. 2 is a simplified block diagram illustrating additional details associated with communication system 10. FIG. 2 illustrates a number of network elements that can be configured to have the loopback capabilities being discussed herein. For purposes of simplicity, there are four examples of network elements being provisioned with the loopback intelligence; however, it is imperative to note that virtually any device in the network could have this functionality. In the particular example of FIG. 2, IP phone 16, IP phone 18, border element 24, and border element 26 each have a respective loopback module 40a-d, a respective processor 42a-d, and a respective memory element 44a-d.

IP phones 16, 18, border elements 24, 26, Telepresence endpoints 20, 22 are all representative of network elements (e.g., IP devices of various forms) that can be used to initiate (or otherwise to facilitate) the loopback activities disclosed herein. Each of these network elements can facilitate any type of data propagation in a given network (e.g., for networks such as those illustrated in FIG. 1). As used herein in this Specification, the term ‘network element’ is meant to encompass routers, switches, gateways, bridges, loadbalancers, firewalls, inline service nodes, proxies, servers, processors, modules, computers, databases, or personal computing devices (e.g., phones of any kind, laptops, etc.), or any other suitable device, component, element, proprietary appliance, or object operable to exchange information in a network environment.

The term ‘computer’ mentioned above is inclusive of devices used to initiate a communication such as a laptop, a personal digital assistant (PDA), an electronic notebook, a cellular telephone, an iPhone, a Blackberry, a smartphone, a tablet, an iPad, an IP phone, or any other device, component, element, or object capable of initiating data exchanges within communication system 10. The computer identified above can be inclusive of a suitable interface to the human user, such as a display, or a keyboard or other terminal equipment.

For example a display (e.g., an application interface, a graphical user interface (GUI), etc.) can be provided to a network administrator for managing the loopback activities discussed herein. For example, the interface can manage network elements, strategize about appropriate loopback paths, receive recommendations for potential loopback paths, receive feedback and diagnostics data about the network, receive alerts or reports about the network (e.g., round trip times, delays, degradation issues, etc.). Note that such a computer may also be any device that seeks to initiate a communication on behalf of another entity or element, such as a program, a database, or any other component, device, element, or object capable of initiating an exchange within communication system 10. Data, as used herein in this document, refers to any type of packet data, diagnostic data, fault, configuration, accounting, performance, security (FCAPS) data, network management system (NMS) data, numeric, voice, video, media, or script data, or any type of source or object code, or any other suitable information in any appropriate format that may be communicated from one point to another. Note that this network element may include any suitable hardware, software, components, modules, interfaces (e.g., for receiving and transmitting data in a network environment), or objects that facilitate the operations thereof. This may be inclusive of appropriate algorithms and communication protocols that allow for the effective exchange of data or information.

In one implementation, each of these network elements (or selected network elements) include software to achieve (or to foster) the loopback operations, as outlined herein in this Specification. This software can be provided as a module (e.g., loopback module 40a-d) to achieve these loopback operations. In other instances, the loopback capability itself can be provisioned as an independent device, or as a proprietary element. Note that in one example, each of the network elements have an internal structure (e.g., a processor, a memory element, etc.) to facilitate some of the operations described herein. In other embodiments, these loopback operations may be executed external to these elements, or included in some other network element to achieve this intended functionality. In certain embodiments, network elements may include reciprocating loopback software that can coordinate with other network elements in order to achieve the operations, as outlined herein.

IP network 30 represents a series of points or nodes of interconnected communication paths for receiving and transmitting packets of information that propagate through communication system 10. IP network 30 offers a communicative interface between sources and/or hosts, and may be any local area network (LAN), wireless local area network (WLAN), metropolitan area network (MAN), Intranet, Extranet, WAN, virtual private network (VPN), or any other appropriate architecture or system that facilitates communications in a network environment. IP network 30 may implement a UDP/IP connection and use a TCP/IP communication language protocol in particular embodiments of the present disclosure. However, IP network 30 may alternatively implement any other suitable communication protocol for transmitting and receiving data packets within communication system 10.

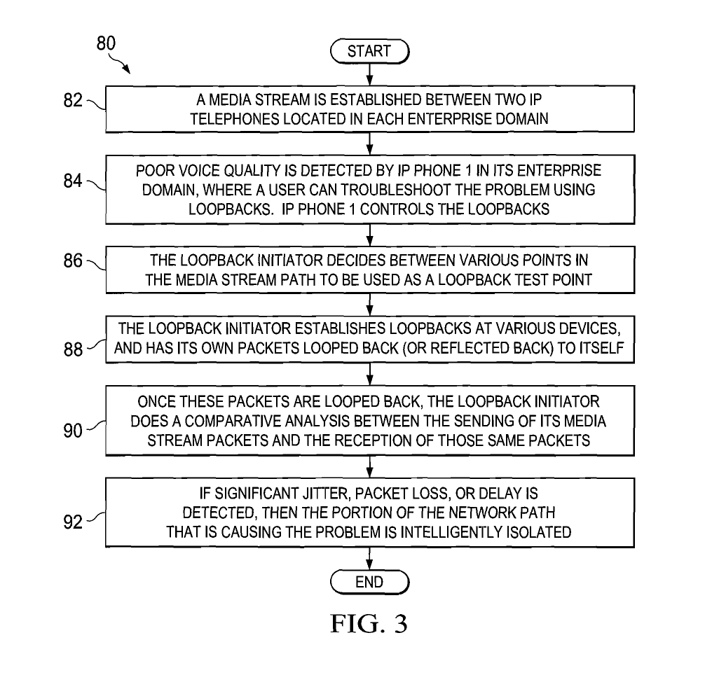

FIG. 3 is a simplified flowchart 80 illustrating one possible flow that can be initiated in communication system 10 (illustrated by FIG. 1). In the IP voice media stream example of FIG. 1, a media stream can be established between two IP telephones located in each enterprise domain. This is illustrated by step 82. At step 84, poor voice quality can be detected by IP phone 16 in enterprise domain 12, where a user (or a network administrator) can troubleshoot the problem using loopbacks. In this particular example, IP phone 16 in enterprise domain 12 controls the loopbacks, and for this reason it is referred to as the loopback initiator. For example, a soft button can be provisioned on IP phone 16 for initiating (or otherwise controlling and managing) loopback activities.

At step 86, the loopback initiator can decide between various points in the media stream path to be used as a loopback test point. In this example, border elements 24 and 26 have a loopback functionality, along with the remote endpoint (IP phone 18). At step 88, the loopback initiator can then establish loopbacks at each of these devices and, further, the loopback initiator can have its own packets looped back (or reflected back) to itself. Once these packets are looped back, it is easy for the loopback initiator to do a comparative analysis between the sending of its media stream packets and the reception of those same packets. This is reflected by step 90. If significant jitter, packet loss, and/or delay is detected, then it is simple to start isolating the portion of the network path that is causing the problem. This is reflected by step 92. Note that a human user can certainly detect or sense certain degradation issues through simple hearing. Stated differently, a network administrator (during loopback testing) would not have to rely exclusively on the loopback diagnostic data, where he could be involved in the detection and evaluation activities to pinpoint a source of the network problem.

For example, if IP phone 16 can loopback border element 24 and see that the packets that are looped back to it are functionally okay, then this clears the customer IP network at enterprise domain 12 as the cause of the poor voice quality. Subsequently, IP phone 16 could loopback border element 26, where this can test the path between IP phone 16 and border element 26 (including the IP network at enterprise domain 12, along with the SIP provider network). The processing on IP phone 16 can simply execute basic stats to check for delay, packet loss, excessive jitter, round-trip times, or any other characteristic associated with a media session. IP phone 16 knows when it transmits an RTP voice packet with a specific sequence number, and then it simply waits for that packet to return to calculate voice quality statistics. By being able to loopback devices in the media stream path and even the endpoint, IP phone 16 can break down the media path into segments and intelligently isolate the network piece that is causing the issue.

Devices in the path that are implementing a loopback on a particular media stream can perform a straightforward function. A given device, such as a border element (or any other L3 device supporting such a loopback functionality) would receive the media stream from IP phone 16 and loop it back to IP phone 16. In a general sense, the device is swapping source and destination IP addresses (and ports), and sending the packets back out over the same interface on which they were received.

In a second example (again with reference to the architecture of FIG. 1), an IP video media stream can be established between two Telepresence endpoints 20 and 22. However, in this case Telepresence endpoint 22 in enterprise domain 14 can perform loopback testing. Along with the previous example, this example illustrates how loopback testing can be initiated from either endpoint device and the device can be voice or video, or other media streaming applications.

Referring now to certain probing activities, certain embodiments of the present disclosure can involve an automated discovery mechanism with a probe packet. The main difference with this embodiment (from a configuration perspective) is that a generic loopback command is configured for certain interfaces (or even dial-peers in the case of a particular voice gateway or a particular border element). For example, the following command could be used in such scenarios: ‘interface g1/0/0 loopback media enable.’ This command could enable two functions on a given receiving device. The first function is that the device now responds to loopback probe packets sent down a media stream path. The second function is that this device responds to an actual loopback request packet, once the probe discovery has been completed.

In operation, the loopback discovery probe can operate as follows. At any point during a media conversation, either endpoint can initiate loopback troubleshooting. However, before the loopbacks are initiated, it is beneficial to map and determine what devices in the media stream path support loopbacks. Hence, a loopback discovery probe packet can be sent by the endpoint to create a mapping of the loopback points present in the media stream path. Note that such a mapping can be embodied in any suitable form (e.g., a storage element, a table, a chart, etc.). As used herein in this Specification, the generic term ‘list’ encompasses all such possibilities.

The loopback probe can be created using a few different methods. One method could use Service Assurance Agent (SAA) probes. These probes can be sent in an RTP media stream and, further, can be used by modern voice gateways to measure packet loss, delay, and/or jitter. A node counter field can be added to this probe, where a unique identifier is provided for mapping loopback points in a media path.

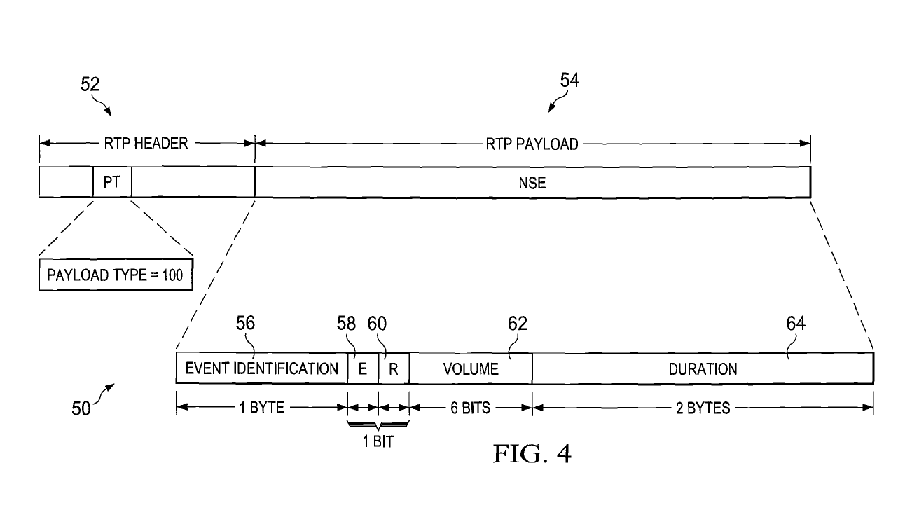

Turning to FIG. 4, FIG. 4 is a simplified block diagram of an example packet format 50 associated with the present disclosure. Operationally, packet format 50 offers a mechanism that may be used to initiate (or to automate) loopback activities in a network environment in accordance with the teachings of the present disclosure. Further, this particular packet format 50 can signal the starting and stopping of the loopback activities. Packet format 50 includes a real-time protocol (RTP) header 52, which identifies a payload type. Packet format 50 also includes an RTP payload 54, which may include a named signaling event (NSE) segment in this particular example.

Also provided within RTP payload 54 is an event ID 56 that offers an identifier for specifying the purpose of the NSE message. An end bit 58 is also included, and this specifies the end of the event when it is set. A reserved bit 60 is set to zero and reserved for potential future use. A set of volume bits 62 represents the signal power level for dual-tone multi-frequency (DTMF) digits and/or other events representable as tones. Furthermore, RTP payload 54 may include a set of duration bits 64. Duration bits 64 are typically used for events such as DTMF in order to express the duration of the channel in timestamp units.

Another mechanism for implementing the loopback discovery probe would be to use a Named Telephony Event (NTE) packet [as described in RFC 2833]. In either event, these packets can be RTP encapsulated, and exchanged as part of the media stream flow. Many networking elements already use these types of packets to signal media switchovers by specifying certain values or event IDs in the NTE/NSE payload. A unique event ID for the loopback discovery probe can be added, as well as incrementing the node counter for tracking the loopback points for either type of packet (NTE packets, NSE packets, or other types of packets). This could include new types of loopback probe packets being created (which may be proprietary in nature), or NTE packets and NSE packets could be easily modified for such an application.

In operational terms, the loopback activities discussed herein could be logically divided into three separate mechanisms. Each of these mechanisms may have multiple functions and/or particular provisioning configurations, which may be based on certain scenarios or specific operator needs. The first mechanism includes enabling and detecting loopback support on a device. The second mechanism includes signaling to start and to stop loopbacks in the media stream. The third mechanism addresses media stream handling in the opposite direction of the loopback.

For the first mechanism, devices in the media path should support the looping back of a particular media stream. Note that this first mechanism of enabling and detecting loopback support on a device can be accomplished in two ways: through a detection probe and through the more manual method (both ways being described below). Hence, in addition to the loopback discovery method, another method involves a complete manual configuration through a CLI or a web-based configuration, for example.

In certain cases, network administrators may not want specific L3 devices to act as a loopback point within the media path. Therefore, the support of a media loopback can be configurable on a given device. In a particular implementation, enabling the media loopback capability on an L3 transit device can be performed through a CLI or web-based configuration. In the case of certain routers and gateways, a command on an interface such as the following would achieve this objective: ‘interface g1/0/0 enable media-loopback first-node incoming.’ Additionally, a command such as ‘enable media-loopback first-node incoming’ could specify that this interface would respond to incoming media stream loopback signals on this interface. Additionally, this interface is tagged as the first loopback node in the media stream. This is important because multiple nodes in the media stream path would be capable of responding to a loopback signal. The multiple loopback points in a media stream path could be differentiated by their node position (first, second, third, etc.) relative to the media stream originator.

A network administrator can configure and enable the loopback points in the network at critical points and network junctions. Once this configuration is completed, then the network is ready to act upon media stream loopback signals: whenever the need arises. From the media stream originator, a command requesting a media stream loopback at a particular loopback node can be requested. The loopback requester can specify the loopback node (first, second, third, etc.) in the media stream path for loopback activities.

For the second mechanism (addressing signaling to start and stop loopbacks in the media stream), the actual signaling can occur using any number of possible implementations. One particular implementation can build on the probe discovery mechanism using SAA-type probes or NTE/NSE packets that were discussed previously. Another second implementation can involve manipulating fields in the IP header of media stream packets. Functionally, these methods allow an endpoint to start and to stop a loopback at a particular node in the media stream path.

Referring to the first possible implementation, such a configuration can leverage the IP SAA probe. This probe packet can be sent over an existing media stream session. In this IP SAA packet, the node number and a ‘loopback enable’ or ‘loopback disable’ request can be flagged. The node number is simply a count of the loopback nodes from the endpoint with node 1 being the closest loopback point, node 2 being the next closest, and node n being the last loopback node. The last loopback node is often the terminating endpoint. The SAA packet can match the rest of the packets in the IP media stream in terms of headers (IP, UDP, RTP, etc.) and IP address and port numbers. The RTP payload type can be different to separate this loopback signaling message from the actual media. Other L3 transit devices, which do not have the media stream loopback support configured on them, can simply route the packet as it would route any other packet.

The endpoint can treat this packet in one of two ways. First, if the endpoint is configured for supporting the loopback feature and the SAA probe specifies its node number, then the endpoint can loopback the media stream. Second, if the endpoint does not support a loopback functionality, the loopback function is not enabled, or the node number is not its own, then the endpoint can simply discard the SAA packet. Recall that the RTP probe packet (and the loopback signaling packet) can use a different RTP payload type than the media stream. The payload type for the SAA packet can fall into the RTP dynamic or unassigned range.

A second possible implementation can use the NTE/NSE packets, which were also used for the loopback discovery probe functionality. When used to enable/disable loopbacks at specific nodes in the media path, such packets can achieve the same result as that detailed above with the SAA methodology. This would allow for loopbacks to be started and stopped at any node in the network that responded to the discovery probe packet. Within the NTE/NSE loopback request packet would be a setting for the node number and, further, whether the loopback of the media stream should be started or stopped. This NTE/NSE packet could be sent in the RTP media stream using a different RTP payload type to distinguish it from the actual media.

Certain router and gateway designs currently implement NTE messages with an RTP payload type of 101, where NSE packets use a payload type of 100. These values fall into the unassigned/dynamic range as defined in RFC 3551. The node in the media path that matches the node number in this NTE/NSE packet can execute the requested behavior of starting or stopping a media stream loopback. Other nodes can ignore this packet, and route it as a regular L3 packet. The format for an NSE packet is depicted in FIG. 4. The NTE packet format as described in RFC 2833 is the same except that the RTP payload type value is different. The event ID for either NTE/NSE packets could be a unique value to indicate that this is a loopback start or stop message. The node number could be indicated in the volume or duration fields.

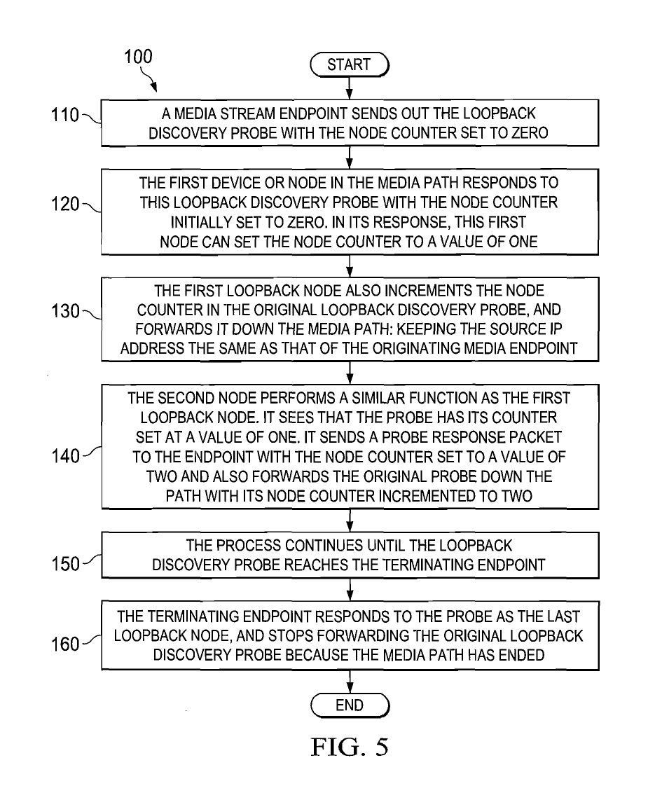

FIG. 5 is a simplified flowchart 100 illustrating example steps associated with a node counter mechanism. Note that the node counter mechanism mentioned with both the SAA and NSE loopback discovery implementations can be used for tracking and mapping the loopback points in the media path. This particular flow can begin at step 110, where a media stream endpoint sends out the loopback discovery probe with the node counter set to 0. At step 120, the first device or node in the media path (configured to act as a loopback point) responds to this loopback discovery probe with the node counter initially set to 0. In its response, this first node can set the node counter to a value of 1, and return it to the originating endpoint. Once this response is received, the endpoint knows that the device that sent this probe response is the first loopback point. Additionally, the first loopback node also increments the node counter in the original loopback discovery probe, and forwards it down the media path: keeping the source IP address the same as that of the originating media endpoint. This is illustrated by step 130.

At step 140, the second node (capable of media stream loopbacks) performs a similar function as the first loopback node. It sees that the probe has its counter set at a value of 1. It sends a probe response packet to the endpoint with the node counter set to a value of 2, and also forwards the original probe down the path with its node counter incremented to 2. At step 150, the process continues until the loopback discovery probe reaches the terminating endpoint. The terminating endpoint then responds to the probe as the last loopback node, but stops forwarding the original loopback discovery probe because the media path has ended. This is illustrated at step 160.

Implementing the node counter as part of the loopback discovery probe is important for mapping the potential loopback points in a media path. Once all of the responses are received by the endpoint, it can then display to the network administrator (e.g., through a GUI) the loopback points that are available. The display can include an ordering of loopback points from closest to farthest in a list. Users can then review the list to choose particular loopback points to test for troubleshooting the media stream.

Logically, most users would probably test the closest loopback point to see if there is a problem at that node. If the problem is seen at the first loopback point, then the user would know that the media stream degradation is occurring between the endpoint initiating the loopback and the first loopback point. This signals the appropriate location for the focus of additional troubleshooting, as there is no need to troubleshoot other network path segments. If the problem is not seen at the first loopback point, then testing to the next closest loopback point can be initiated. Eventually a loopback point will show degradation during loopback testing, and the user has accurately determined that the problem resides between the last clean loopback test point and the one that is currently showing media stream degradation. Again, such a protocol would effectively isolate a network path segment for troubleshooting, which offers a much quicker resolution of media stream degradation issues.

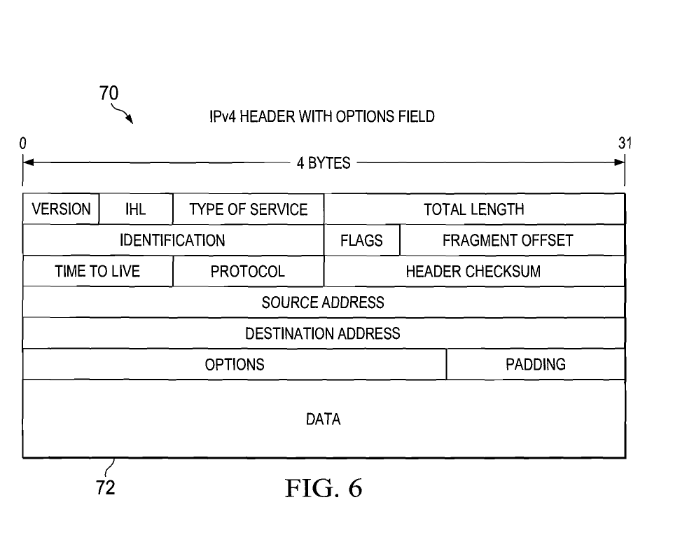

FIG. 6 is a simplified block diagram illustrating another mechanism that can be used in loopback activities. FIG. 6 illustrates an IPv4 header format 70 with an options field 72. In a general sense, certain architectures of the present disclosure may use IP header fields to indicate the node number and, further, whether a loopback should be enabled or disabled. While not used much, options field 72 could easily be used for both signaling when a loopback should be enabled and disabled. The main benefit of using this mechanism is that the implementation is simple. Network devices already evaluate the IP header for routing packets. Hence, having a network device look at the options field in an IP header would not be difficult. In this IP header options field 72 (just as is the case with the SAA and NSE/NTE embodiments), a node number (as well as a loopback enable or disable command) would be present. Note that such a mechanism can be further extended, where options field 72 in the IP header could be used for the automated loopback discovery activities (e.g., using a probe as described above).

For the third mechanism, note that there should be some coordination of media streams, which can be managed in a direction that is opposite to that of the initial loopback direction. Typically, when a media stream is looped back to one endpoint by a node, the integrity of the media stream to the other endpoint should be maintained. This can be achieved using a number of mechanisms: some of which are detailed herein. In one embodiment, the two endpoints can communicate as normal with a full bi-directional flow, but the originating endpoint can setup an independent media session using the same IP information as the originating media stream. This could include using a different a synchronization source (SSRC) (but predictable, for instance+1 of the original SSRC) and using a specific payload type (e.g., dynamic PT=127) to make the new media loopback session easier to identify by downstream border elements. The new session could allow downstream border elements to key on this similar media stream and, further, only loopback the new media stream and not the original. This would simplify the passthrough mechanism of the originating media stream, and also preserve the media and the signaling corresponding to that originating media stream.

In another embodiment, the architecture can use a more simplistic passthrough by allowing the originating media stream to pass through the border element uninterrupted, but looping the originating media stream back onto itself. This could allow the loopback node to pass through the media to the remote side, while at the same time looping back the same media stream to the originating endpoint device. This can be done while preserving the call signaling of the originating media stream. The endpoint could also playback a standard loopback message stating that the call is currently under maintenance and, further, instructing the far end not to hang-up during the brief testing period. Note that for codecs or implementations that use voice activation detection (VAD) and that generate silence descriptors (e.g., Silence Insertion Descriptor (SID) packets), a SID packet indicating a silence period can be sent. It should not be necessary to send additional packets during the loopback testing, unless the VAD mechanism sends periodic SIDs to keep the media stream current.

Note that in certain example implementations, the intelligent loopback functions outlined herein may be implemented by logic (i.e., potentially non-transitory) encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element [as shown in FIG. 2] can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor [as shown in FIG. 2] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

In one example implementation, the network elements (e.g., IP phones, routers, border elements, Telepresence endpoints, etc.) may include software in order to achieve the intelligent loopback functions outlined herein. These activities can be facilitated by loopback modules 40a-d, where processing components can be suitably combined or consolidated in any appropriate manner, which may be based on particular configuration and/or provisioning needs. Additionally, the network elements may include a processor that can execute software or an algorithm to perform the intelligent loopback operations, as disclosed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein (e.g., database, tables, maps, lists, cache, etc.) should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that with the example provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its teachings) are readily scalable and can accommodate a large number of components, as well as more complicated/sophisticated arrangements and configurations. Accordingly, the examples provided should not limit the scope or inhibit the broad teachings of communication system 10, as potentially applied to a myriad of other architectures.

It is also important to note that the steps in the preceding flow diagrams illustrate only some of the possible signaling scenarios and patterns that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain endpoints and certain protocols (e.g., certain types of tunneling, certain types of commands, etc.), communication system 10 may be applicable to other protocols and arrangements. Moreover, the present disclosure is equally applicable to various technologies, not simply limited to voice and audio. The real-time loopback methods described herein are applicable to voice, video, or any other type of media stream, where the preceding descriptions have only been offered for purposes of discussion. Additionally, although communication system 10 has been illustrated with reference to particular elements and operations that facilitate the communication process, these elements and operations may be replaced by any suitable architecture or process that achieves the intended functionalities of communication system 10.

What is claimed is:

1. A method, comprising:
establishing a path for a media session between a first network element and a second network element;
detecting a third network element along the path;
receiving a response from the third network element indicating that it is capable of performing a loopback activity that involves the first network element; and
communicating a test packet from the first network element to the third network element in order to evaluate characteristics associated with the media session.

2. The method of claim 1, wherein the response includes an indication as to a proximity of the third network element in relation to the first network element.

3. The method of claim 1, wherein the first network element receives additional responses from a plurality of network elements such that the first network element generates a list of available network elements for performing loopback activities.

4. The method of claim 1, wherein a probe packet is communicated to the third network element to evaluate eligible loopback points in the path.

5. The method of claim 1, wherein a control packet enables a loopback operation to be initiated at the third network element.

6. The method of claim 1, wherein the characteristics associated with the media session include jitter, packet loss, and delay associated with the media session.

7. The method of claim 1, wherein media session includes video data, audio data, or voice data.

8. Logic encoded in one or more tangible media that includes code for execution and when executed by a processor operable to perform operations comprising:
establishing a path for a media session between a first network element and a second network element;
detecting a third network element along the path;
receiving a response from the third network element indicating that it is capable of performing a loopback activity that involves the first network element; and
communicating a test packet from the first network element to the third network element in order to evaluate characteristics associated with the media session.

9. The logic of claim 8, wherein the response includes an indication as to a proximity of the third network element in relation to the first network element.

10. The logic of claim 8, wherein the first network element receives additional responses from a plurality of network elements such that the first network element generates a list of available network elements for performing loopback activities.

11. The logic of claim 8, wherein a probe packet is communicated to the third network element to evaluate eligible loopback points in the path.

12. The logic of claim 8, wherein a control packet enables a loopback operation to be initiated at the third network element.

13. The logic of claim 8, wherein the characteristics associated with the media session include jitter, packet loss, and delay associated with the media session.

14. An apparatus, comprising:
a memory element configured to store data,
a processor operable to execute instructions associated with the data, and
a loopback module, the apparatus being configured to:
establish a path for a media session between a first network element and a second network element;
detect a third network element along the path;
receive a response from the third network element indicating that it is capable of performing a loopback activity that involves the first network element; and
communicate a test packet from the first network element to the third network element in order to evaluate characteristics associated with the media session.

15. The apparatus of claim 14, wherein the response includes an indication as to a proximity of the third network element in relation to the first network element.

16. The apparatus of claim 14, wherein the first network element receives additional responses from a plurality of network elements such that the first network element generates a list of available network elements for performing loopback activities.

17. The apparatus of claim 14, wherein a probe packet is communicated to the third network element to evaluate eligible loopback points in the path.

18. The apparatus of claim 14, wherein a control packet enables a loopback operation to be initiated at the third network element.

19. The apparatus of claim 14, wherein the characteristics associated with the media session include jitter, packet loss, and delay associated with the media session.

20. The apparatus of claim 14, wherein media session includes video data, audio data, or voice data.

21. The apparatus of claim 14, wherein the first network element and the third network element conduct a bi-directional media session independent of the loopback activity.

22. The apparatus of claim 14, wherein the third network element is configured to pass portions of the media session to a next destination in addition to looping back data to the first network element that initiated the loopback activity.

23. The apparatus of claim 14, wherein the first network element is configured to communicate a loopback message to the third network element indicating that the media session is undergoing testing such that the third network element does not terminate the media session during a testing period.
